(19) United States
(12) Patent Application Publication
(10) Pub. No.: US 2021/0268600 A1
(43) Pub. Date: Sep. 2, 2021

(54) MANUFACTURING METHOD OF SPATIALLY MODULATED WAVEPLATES

(71) Applicant: UAB ALTECHNA R&D, Vilnius (LT)

(72) Inventors: Orestas ULCINAS, Vilnius (LT); Titas GERTUS, Vilnius (LT); Antanas URBAS, Vilnius (LT)

(21) Appl. No.: 17/254,600

(22) PCT Filed: Jun. 21, 2019
(86) PCT No.: PCT/IB2019/055248

§ 371 Date: Dec. 21, 2020

(30) Foreign Application Priority Data
Jun. 22, 2018 (LT) 2018 020

(51) Int. Cl. B23K 26/00; B23K 26/0622; B23K 26/53; B23K 26/064; B23K 26/08; C03C 23/00; G02B 5/30

(52) U.S. Cl. CPC B23K 26/0006; B23K 26/0624; B23K 26/53; B23K 2103/54; B23K 26/08; C03C 23/0025; G02B 5/3083; B23K 26/064

(57) ABSTRACT

The invention relates to volume modification of transparent materials by means of ultrashort laser pulses. A method for manufacturing of highly transparent spatially variant waveplates includes focusing Gaussian laser beam with pulse duration 500 fs to 2000 fs inside of material transparent to laser wavelength building self-organizing structures of nanoplates. The workpiece is moved in three coordinates relatively to beam focus along desired line. A combination of focus area, pulse repetition rate, energy and velocity of movement is selected to locate said structures inside of the workpiece for acting as birefringent optical elements with specific retardance. Energy of pulses exceeds the threshold of building nanoplates in part of the focal area limited by −σ/2 and σ/2 where σ is standard deviation from maximum of Gaussian function. Energy of pulses creating nanoplates is accumulated in said area from the sequence of 1000 to 2000 pulses in total not exceeding 0.2-0.3 μJ.

### FIELD OF TECHNOLOGY

The invention is related to methods of volumetric modification of transparent material properties through the use of ultrashort laser pulses. More specifically, it is related to the laser manufacturing of spatially-modulated waveplates.

### LEVEL OF TECHNOLOGY

It is known (see e.g., Sudrie L., et al., “Study Of Damage In Fused Silica By Ultra-Short IR Laser Pulses,” Opics Communications, t. 191, pp. 333-339, 2001.) that when molten quartz and some glasses are affected with ultrashort (80-500 fs duration) pulses, with a suitable combination of pulse duration and its energy, they produce periodic structures of refractive index changes (Hirao, K., Miura, K., “Writing Waveguides And Gratings in Silica And Related Materials by a Femtosecond Laser.” J. Non-Crystalline Solids, t. 239, pp. 91-95, 1998., Davis, K. M., et al., “Writing Waveguides in Glass With a Femtosecond Laser,” Opt. Lett., t. 21, pp. 1729-1731, 1996., Hnatovsky c., et al., “Pulse duration dependence of femtosecond-laser-fabricated nanogratings in fused silica,” Appl. Phys. Lett, t. 87, No. 014104, pp. 1-3, 2005.), characterized by small dimensions, several times smaller than the wave length of the affecting light, and the occurrence of a twofold light refraction. The size difference between the refractive indexes for ordinary and extraordinary waves usually is of 10⁻² order. These structures are extended in the direction of light propagation and have the form of a periodic grating, perpendicular to the polarization vector of the affecting light (Shimotsuma, Y., et al., “Self-Organized Nanogratings in Glass Irradiated by Ultrashort Light Pulses,” Phys. Rev. Lett., t. 91, No. 24, pp. 1-4, 2003. Bhardwaj, V. R., et al, “Optically Produced Arrays of Planar Nanostructures inside Fused Silica,” Phys. Rev. Left., t. 96, No. 10 February, pp. 1-4, 2006.), and the fast axis of the birefringence is parallel to that vector (Bricchi, E., et al., “Form Birefringence and Negative Index Change Created by Femtosecond Direct Writing in Transparent Materials,” Opt. Lett., t. 29, pp. 119-121, 2004.; Champion, A., et al., “Stress Distribution Around Femtosecond Laser Affected Zones: Effect of Nanogratings Orientation,” Opt. Express, t 21, pp. 24942-24951, 2013.). The formation of the structure is a threshold process requiring that the intensity of the light that is affecting the substance would exceed the value characteristic to the material (R. e. a. Taylor, “Fabrication of Long Range Periodic Nanostructures in Transparent or Semitransparent Dielectrics”. U.S. Pat. No. 7,438,824B2, 21 Oct. 2008. Shimotsuma, Y., et al., “Self-Organized Nanogratings in Glass Irradiated by Ultrashort Light Pulses,” Phys. Rev. Lett., t. 91, No. 24, pp. 1-4, 2003.; Bhardwaj, V. R., et al., “Femtosecond Laser-induced Refractive Index Modification in Multicomponent Glasses,” J. Appl. Phys., t. 97, No. 083102, pp. 1-12, 2005.; M. Li, “Method of Precise Laser Nanomachining With UV Ultrafast Laser Pulses”. U.S. Pat. No. 7,057,135B2, 6 Jun. 2006). The created effect is also amplified by repeatedly affecting that area with the sequential laser pulses, i.e. the accumulation effect is observed. (Bonse, J., Krueger, J., “Pulse Number Dependence of Laser-Induced Periodic Surface Structures for Femtosecond Laser Irradiation of Silicon,” J. Appl. Phys., t 108, No. 034903, pp. 1-5, 2010.; Zimmermann, F., et al., “Ultrashort laser pulse induced nanogratings in borosilicate glass,” Applied Physics Letters, t. 104, No. 211107, pp. 1-5, 2014.; Richter S., et al., “Nanogratings in fused silica: Formation, control, and applications,” J. Laser Appl., t. 24, No. 4, pp. 042008-1-8, 2012). The formation of nanostructures is explained by the interaction of the affecting light with waves of the induced plasma, duration of which is about 100-150 fs. (Petite G., et al., “Conduction electrons in wide-bandgap oxides: A subpicosecond time-resolved optical study,” Nucl. Instrum. Methods Phys. Res. B, t. 107, pp. 97-101, 1998. Martin, P., et al., “Subpicosecond study of carrier trapping dynamics in wide-band-gap crystals,” Phys. Rev. B, t. 55, pp. 5799-5810, 1997.). It is said (Taylor, R., Hnatovsky, C, Simova, E., “Applications of femtosecond laser induced self-organized planar nanocracks inside fused silica glass,” Laser Photonics Rev., t. 2, pp. 26-46, 2008.; Lancry, M., et al., “Compact Birefringent Waveplates Photo-Induced in Silica by Femtosecond Laser,” Micromachines, t. 5, pp. 825-838, 2014.) that due to that interaction, randomly distributed plasma nanospheres are formed, which, due to the amplification of the field at their edges, are bound into plates, oriented perpendicularly to the polarization plane, these in turn for the short term, exhibit metallic properties and affect the propagation of light. By interacting with the illuminating material, those plasma spheres create openings of the nanometer order (Lancry, M., et al., “Compact Birefringent Waveplates Photo-Induced in Silica by Femtosecond Laser,” Micromachines, t. 5, pp. 825-838, 2014.), there the changes of the refractive index, influenced by defects of the material grating, and the appearance of birefringence are observed. Changes form as the light created effects accumulate in the material grating, and this manifests by both the increase of the size of the created effect and the decrease of the distances between the atoms (the grating period) (Richter S., et al., “Nanogratings in fused silica: Formation, control, and applications,” J. Laser Appl., t. 24, No 4, pp. 042008-1-8, 2012.). The light energy, which fell into the sample, is accumulated, i.e. in order to achieve the same process threshold (Rajeev, P. P, et al., “Memory in nonlinear ionization of transparent solids,” Phys Rev. Lett., t. 97. p. 253001, 2006.) or the number of induced defect centers (Richter, S. et al., “The role of self-trapped excitons and defects in the formation of nanogratings in fused silica,” Opt. Left., t. 37, pp. 482-484, 2012.), the required amount of pulse energy and effect generating impulses is roughly constant (Richter S., et al., “Nanogratings in fused silica: Formation, control, and applications,” J. Laser Appl., t. 24, No. 4, pp. 042008-1-8, 2012.). The gap between incoming consecutive pulses is important for the accumulation. It was noted that the efficiency of the formation of periodic structures decreases significantly if the pulses are separated beyond a certain threshold value, which depends on the pulse energy, e.g., for 115 nJ pulses it is ˜20 ps, and for 452 nJ-˜100 ps gap. However, the formation of periodic structures is observed up to a pulse repetition frequency R˜=0.1 Hz, i.e. gap between pulses ˜10 s (Richter S., et al., “Nanogratings in fused silica: Formation, control, and applications,” J. Laser Appl., t. 24, No. 4, pp. 042008-1-8, 2012.). This suggests that the accumulation of the effect is associated with several physical processes with clearly different characteristic durations. First of all, the electric field of the light pulse generates free electrons. The electron-hole pairs (excitons) formed in this way bind with the fluctuations of the material grating (phonons), and are captured by the irregularities of the grating or by the field deformations created by the excitons themselves (self-trapped excitons, STE) (Williams, R., Song, K., “The self trapped exciton,” J. Phys. Chem. Solids, t. 51, pp. 679-716, 1990.). These processes proceed very fast, faster than 150 fs (Petite G., et al., “Conduction electrons in wide-bandgap oxides: A subpicosecond time-resolved optical study,” Nucl. Instrum. Methods Phys. Res. B, t. 107, pp. 97-101, 1996. Martin, P., et al., “Subpicosecond study of carrier trapping dynamics in wide-band-gap crystals,” Phys. Rev. B, t. 55, pp. 5799-5810, 1997.), therefore, it obviously does not affect the accumulation of the effect. At the room and higher temperatures. STE relax in a non-radiative manner, creating permanent or long-term defects (Stathis, S., Kastner, M., “Time-resolved photoluminescence in amorphous silicon dioxide,” Phys. Rev. B, t. 39, pp. 11183-11186, 1989.), such as E′-centers and nonbridging oxygen hole centers (NBOHC) (Petite G., et al., “Conduction electrons in wide-bandgap oxides: A subpicosecond time-resolved optical study,” Nucl. Instrum. Methods Phys. Res. B, t. 107, pp. 97-101, 1996., Stathis, S., Kastner, M., “Time-resolved photoluminescence in amorphous silicon dioxide,” Phys. Rev. B, t. 39, pp. 11183-11186, 1989.). The characteristic duration of these relaxation channels is about 400 ps (Wortmann, D., Ramme, M., Gottmann, J., “Refractive index modification using fs-laser double pulses,” Opt. Express, t. 15, pp. 10149-10153, 2007.), which corresponds to the observed accumulation times. E′-centers are relaxed silicon bonds (≡Si.), while NBOHC are relaxed oxygen bonds (≡Si—O.). Defects of both types can recombine with each other or turn into defects of other types (Nishikawa, H., et al., “Decay kinetics of the 4,4-eV photoluminescence associated with the two states of oxygen-deficient-type defect in amorphous SiO2,” Phys. Rev. Lett., t. 72, pp. 2101-2104, 1994.). For example, due to the insertion of an oxygen atom, NBOHC can turn into a peroxide radical (≡Si—O—O.) (Skuja, L., et al., “Defects in oxide glasses,” Physica Status Solidi C, t. 2, pp. 15-24, 2005.). In any case, the presence of such defects changes the density of the material around them, at the same time the optical properties of the material, such as isotropic and anisotropic refractive index, change as well, i.e. birefringence occurs. Molten quartz, a material in which nano-planes are produced the most effectively, consists of (Si—O)ₙ oxide rings with n members. At the time when the molten quartz is mostly composed of rings with n≈6-7, the appearance of the defects of relaxed bonds can reduce the average ring size to n≈3-4. This is accompanied by a decrease of the angles between the bonds, which leads to the increase of material density, observed after the effects of femtosecond pulses (Chan, J. W., et al., “Modification of the fused silica glass network associated with waveguide fabrication using femtosecond laser pulses,” Appl. Phys. A: Mater. Sci. Process., t. 76, pp. 367-372, 2003.). In the zones with the aforesaid defects, the ionization energy is lower than in the source material, therefore, each subsequent pulse produces more and more defects. On the other hand, the dependence of the periodic structures' formation efficiency on the intensity of the pulse may be partially explained by the dependence of the STE formation on the density of the pulse power (Tsai, T. E., et al., “Experimental evidence for excitonic mechanism of defect generation in high-purity silica,” Phys. Rev. Lett., t 67, pp. 2517-2520, 1991.).

The method for recording periodic structures from nano-planes is detailed in the U.S. Pat. No. 7,438,824 B2. It specifies that periodic nano-plane structures are formed due to effect of the pulse with a duration between 5 and 200 fs (5×10⁻¹⁵ s+200×10¹⁵ s). It is also specified that for stable recording of the structure, the pulse energy must significantly exceed the threshold energy (Eₛₗ) for this effect, at least from 4×Eₛₗ, by focusing the beam with a short focal length (NA=0.65) optical element, which allows to concentrate the energy into a spot with a diameter of ˜2-μm. The workpiece is moved with respect to a laser beam beam focal point at a speed not exceeding 100 μm/s while repeating laser pulses at a frequency of about 250 kHz, which means that an energy of 12.500 pulses is accumulated in the area with a diameter of 5 μm. The energy of a single pulse must be between 75-300 nJ, i.e., from 0.94 mJ to 3.75 mJ laser pulse energy is accumulated in the aforesaid area.

When the set of parameters, described in the U.S. Pat. No. 7,438,824 B2, is used during the manufacturing of optical elements, the significant dependence of the manufactured element optical bandwidth on the laser radiation wavelength is observed, and the bandwidth at the fundamental harmonics (1000-1100 nm) generated by most lasers does not exceed 80%, and at the wavelength of the second harmonic (500-550 nm) reaches only about 50%.

Therefore, the optical elements manufactured in the described manner do not have a sufficient bandwidth required for the efficient processing of materials. Using such elements requires the laser that is at least twice as powerful than would be needed to achieve the desired effect, this in turn greatly increases the cost of the equipment. Furthermore, the large losses of light in the element due to the absorption and diffusion shortens its lifetime and alter the properties of the element during the work process, and this requires readjustment of the equipment due to the changes in the formation of the beam that occur due to the ageing of an element.

US 2014/153097 describes common principle of encrypting subwavelength gratings in fused silica with the aim of producing polarization converter by induced birefringence. This principle equivalent to one of U.S. Pat. No. 7,438,824 B2 enables creating exit light beam with a defined spatial distribution of polarization states. However, this converter does not enable manipulating spatial distribution of the energy of laser radiation.

The problem that is being solved by the invention

The aim of the invention is to increase the bandwidth of spatially modulated waveplates intended for the modification of light beams. For that purpose it is being sought to manufacture spatially modulated waveplates formed from nano-planes, with the optical transmission no smaller than in the range of 75% at wavelengths from 320 nm to 2000 nm.

Disclosure of the Essence of the Invention

According to the proposed invention, the essence of the task solution is that the manufacturing method of the spatially modulated waveplates, which includes focusing of linearly polarised ultrashort pulse laser radiation (USPLR) beam with a Gaussian intensity distribution in the material of a workpiece that is transparent to USPLR beam, a controlled transfer of the said transparent material workpiece with respect to a focused focal point of the USPLR beam in accordance with the preset law, while simultaneously changing the direction of USPLR polarization in the workpiece material, depending on the USPLR beam focal point coordinates in the workpiece, the formation of nano-planes in the spots of the workpiece material affected by the focused USPLR beam, and their self-organized into periodic structures with a period shorter than USPLR wavelength, where the formed periodic structures are oriented perpendicularly to the USPLR polarization and assumes the spot in the workpiece material along the direction of the USPLR propagation, that is longer than the said wavelength of the USPLR more than 100 times, the selection of the focused USPLR beam focal area, the frequency of pulse repetition, energy thereof, and the workpiece moving velocity so that the formed nano-plane structures would position in the workpiece material space and function as birefringent optical elements with their characteristic phase delay, where the pulse duration of the USPLR pulses focused in the workpiece material is from 500 fs to 2000 fs, their repetition period is from 1 μs to 50 μs, and the density of the focused USPLR pulse energy exceeds the threshold determined by properties of the affected material only in the part of the focal area, delivers the said linearly polarized pulses of USPLR beam into the workpiece in sequences, where the selected number of pulses in the said sequence is such that it would ensure the formation of the nano-plane structure in the workpiece material.

The part of the focal area, where the USPLR beam pulse energy density exceeds the threshold determined by the properties of the affected material, is defined by the deviation of the intensity distribution from the peak position, and the said deviation is within the range from −σ/2 to σ/2.

The energy of the sequence comprising USPLR beam pulses, is accumulated in the said part of the focal area, where the periodic nano-plane structure is formed, is between 0.2 and 0.3 μJ.

The number of linearly polarized USPLR pulses in a sequence for the formation of a nano-plane structure is selected in the range from 1000 to 2000.

The Utility of the Invention

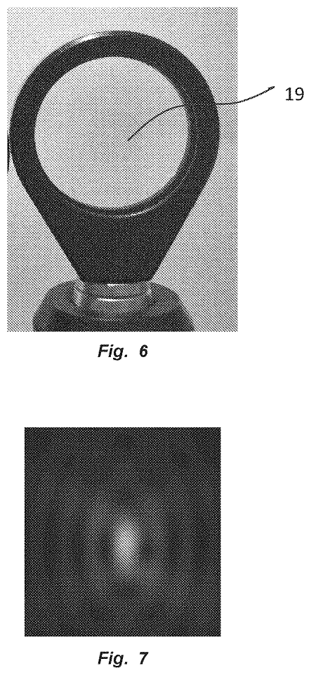

The method for the production of spatially modulated waveplates proposed according to the invention allows to increase their light bandwidth and achieve an optical transparency of no less than 75% in the wavelength range from 320 nm to 2000 nm. As the light losses in a spatially modulated waveplate are reduced, it can be used to form beams of at least twice the intensity. Due to the fact that the transparency reaches more than 75% in the wide wavelength range, the same elements can be used to form laser light beams for its main frequency, as well as its second and even third harmonics. This way, there is no need to manufacture multiple spatially modulated waveplates in order to achieve the same effect in different harmonics of laser radiation. Furthermore, for the stable formation of a nano-plane structure, the USPLR pulse energy density exceeds the threshold energy (Eₛₗ) by no more than 15%, which allows to format an optical element the optical transparency of which is slightly different from the transparency of the material from which it is made. Nanostructures built in the volume of the workpiece allow creation of the optical element that converts entry light beam with Gaussian distribution into an exit light beam with a defined spatial distribution of both polarization states and light intensity (FIG. 7).

The invention is explained with more details through the drawings, where

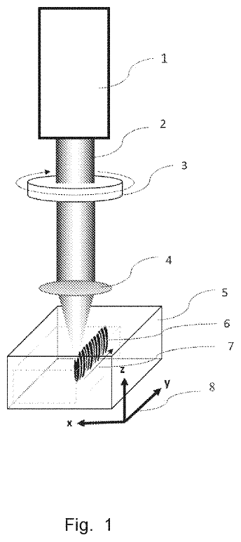

FIG. 1 shows a principal block chart of the device used to implement the proposed method of the spatially modulated waveplate manufacturing;

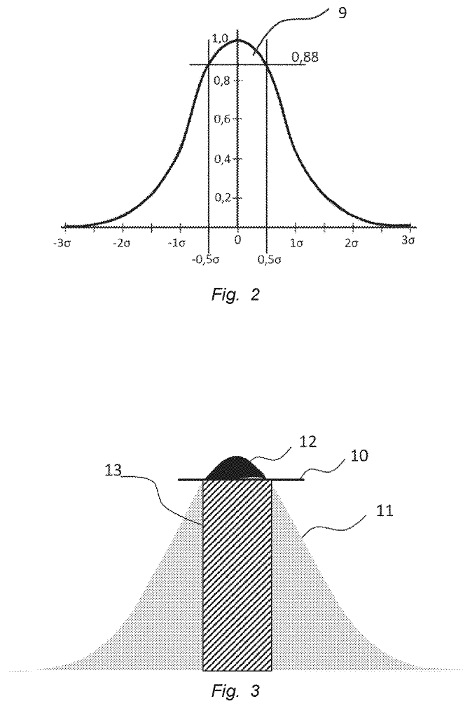

FIG. 2 shows the distribution of the focused USPLR beam intensity, depending on the deviation from the beam axis; if the coordinate deviates from the axis by 0.5σ, where σ is the average deviation, the intensity is 0.88 from the maximum in the axis.

FIG. 3 shows the portion of the focused USPLR beam intensity distribution required for the formation of periodic structures from nanoplates.

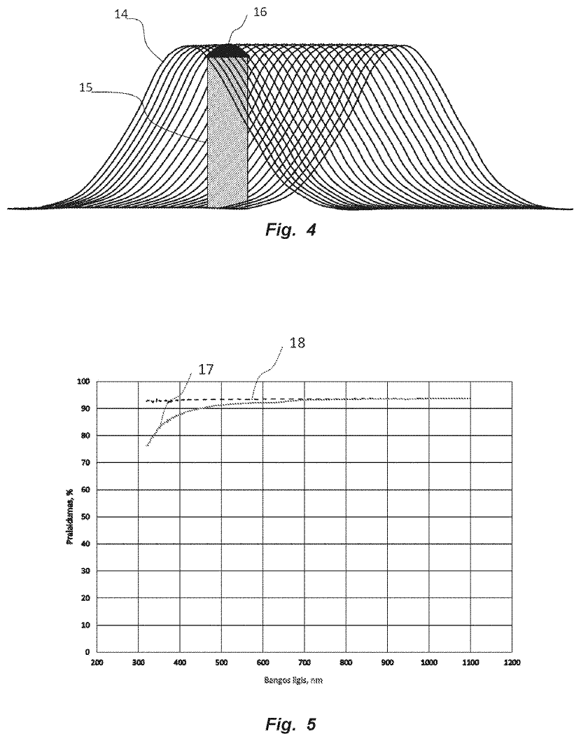

FIG. 4 shows the effect of USPLR impulse energy accumulation in defects.

FIG. 5 shows the spectral bandwidth of an optical element described in a way proposed in this application, by exceeding the threshold for the formation of periodic structures by 10%, and accumulating energy of 1000 pulses, as well as the bandwidth of ultraviolet glass UVFS of which the workpiece of measured element is made.

FIG. 6 shows an optical element manufactured in the manner proposed in the application, its spectral bandwidth is shown in FIG. 5.

FIG. 7 shows an example of spatial distribution of exit light beam obtained from Gaussian entry beam.

### AN IMPLEMENTATION EXAMPLE OF THE PROPOSED INVENTION

The proposed method for the manufacturing of spatially modulated wafeplates includes the following sequence of operations: focuses the radiation beam of the ultrashort pulse laser radiation mode TEM₀₀ (USPLR) with the intensity distribution according to the Gauss law and linear polarization, in a workpiece of a material transparent for the said beam. The additional elements set directions of the polarization vector. The duration of the USPLR focused in the workpiece material is selected within the range from 500 fs to 2000 fs, and their repetition period is selected within the range from 1 μs to 50 μs. The energy of single pulses and the area of the focal waist are chosen so that only a small part of the focal area will exceed the threshold for the formation of structures from nano-planes. The energy density of these pulses is no more than 15% above the threshold determined by the properties of the affected material in the said part of the focal area, defined by the deviation of the intensity distribution from the maximum position in the range from −σ/2 to σ/2. The workpiece is moved in relation to the focal point according to the trajectory set, at each point of that trajectory setting the required direction of the focused USPLR polarization and the orienting the nano-plane structures. The area of the focused USPLR beam focal point, the frequency of pulse repetition, the velocity of their energy and workpiece movement is selected in such a way that the resulting nano-plane structures would be arranged in the space of the workpiece material, and would act as birefringent optic elements with the phase delay that is characteristic to them. This way, one or more layers of nano-planes are recorded. Impulse energy accumulated in the said part of the focal area, where the periodic nano-plane structure is formed, is in range from 0.2 to 0.3 μJ. The formation of a nano-plane structure requires a linearly polarized USPLR pulse sequence in which the number of pulses is in the range from 1000 to 2000.

FIG. 1 shows a principal block chart of the device used to implement the proposed method of the spatially modulated waveplate manufacturing. The device includes a laser source 1, generating the beam of ultrashort pulse laser radiation of the Gaussian intensity distribution 2, in the optical path of which a half-wave (λ/2) phase plate 3 for setting the direction of the polarization vector in the USPLR beam, is placed. A focusing optic 4 is arranged behind the plate 3 to direct the laser radiation beam 2 into a workpiece 5 of a material transparent for the USPLR beam, in it a self-organizing periodic structures of nano-planes 6 are created, they are arranged in the set trajectory 7. The positioning device to move the workpiece in three spatial directions 8 is also provided.

In the manufacturing method of the spatially modulated waveplates proposed according to the invention, the defects created in the material are accumulated by creating them with pulses the intensity of which in the focused beam focal point is distributed according to the Gaussian (normal) law 9, and the energy only marginally (no more than 15%) exceeds the nano-plane formation and self-organizing threshold 10. The pulses of such intensity are directed at a workpiece of a material transparent to the affecting light wave and are periodically repeated until the nano-plane structure of the required optical activity is formed. The repetition period is chosen such that, during the time between pulses, all processes related to the formation of defects would end: the release of the electrons−the formation of excitons, the self-trapping of the excitons (formation of STEs), the energy transfer to the grating (thermal processes), and the relaxation of the silicon-oxygen bonds. At least 1 μs, i.e., the laser pulse repetition frequency must not exceed 1 MHz, in order for all of these processes to end. The operation of the optical element is based on the layout of the nano-plane structures in space, where, at each point of the element, the nano-planes are oriented according to the law, set by the requirements of the distribution of laser radiation energy and phase in the laser beam. The energy part 11 located below the nano-plane structure formation threshold influences the accumulation of the described effects such as the formation of centers, but the birefringence of light occurs only due to the pulse peak 12, the area of which does not exceed the Gaussian distribution part, limited to the half of the average deviation σ/2. In order to be able to orient the nano-plane structure, which affects that beam in the most effective way, first of all we must accumulate material defects in the spot where the structure 13 is being created, and then, by aiming the energy 11, which exceeds the threshold 10, at that spot, we achieve that nano-plane structure would form and self-organize in the target, its orientation is perpendicular to polarization of the pulse exceeding the said threshold. This is achieved by moving the workpiece in relation to the beam focal point. Then, at the beginning of the successively following impulses with the convex energy corresponding to the Gaussian distribution 14, in the increasing order, the required defects are accumulated in the material until a pulse exceeding the structure formation and self-organization threshold 10 moves into the target region 15, and the sequence 16 of such pulses creates the nano-plane structure of the desired direction and efficiency. Subsequent laser pulses continue to accumulate defects in descending order, these increase the optical efficiency of the structure. It is important that these residual effects do not accumulate too much, as this results in undesirable light absorption and diffusion centers. Proper structure performance without increasing losses in them is achieved when the number of structure forming pulses is between 1000 and 2000. By selecting proper combination of light focusing area, pulse repetition frequency, energy thereof and workpiece movement speed, it is possible to achieve that the created nano-plane structures would function with maximum efficiency as birefringent and the light diffusion and absorption would be minimal. The effectiveness of such recording is shown by an spectral transparency 17 of the optical element of a curve, described in a way proposed in this application, by exceeding the threshold for the formation of periodic structures by 10%, and accumulating energy of 1000 pulses, as well as the transparency 18 of ultraviolet glass UVFS of which the workpiece of measured element is made, and the image 19 of the optical element manufactured as proposed in the application.

1. Method for manufacturing of spatially variant waveplates, including:
focusing of linearly polarised ultrashort pulse laser radiation (USPLR) beam (2) with Gaussian intensity distribution in the material of a workpiece (5) that is transparent to USPLR beam (2),
performing controlled displacement of the transparent material workpiece (5) with respect to a focused focal point of the USPLR beam (2) in accordance with the predetermined rule, while simultaneously changing a direction of USPLR polarization in the workpiece material, depending on the USPLR beam (2) focal point coordinates in the workpiece (5), wherein
formation of nano-plates in spots of the workpiece (5) material affected by the focused USPLR beam (2) and their self-organization into periodic structures with a period shorter than USPLR wavelength take place, wherein the formed periodic structures are oriented perpendicularly to the USPLR polarization and covers a region in the workpiece material along the direction of the USPLR propagation, that is longer than the said wavelength of the USPLR more than 100 times,
selecting of the focused USPLR beam focal area, a frequency of pulse repetition, energy thereof, and the workpiece (5) moving velocity so that the formed nano-plate structures (6) would position in the workpiece material space and function as birefringent optical elements with their characteristic phase delay, characterized in that a pulse duration of the USPLR pulses focused in the workpiece (5) material is from 500 fs to 2000 fs, their repetition period is from 1 μs to 50 μs, wherein
a density of the focused USPLR pulse energy exceeds the threshold (10) determined by properties of the affected material only in the part of the focal area, the linearly polarized pulses of USPLR beam are delivered into the workpiece in sequences, wherein number of pulses in a sequence (16) is chosen to ensure the formation of the nano-plate structure (6) in the workpiece material.

2. Method according to claim 1, characterized in that the part of the focal area, in which the USPLR beam pulse energy density exceeds the threshold (10) determined by the properties of the affected material, is defined by the deviation of the intensity distribution from the peak position, and the said deviation is within the range from −σ/2 to σ/2.

3. Method according to claim 1 or claim 2, characterized in that energy of the sequence comprising USPLR beam pulses, accumulated in the part of the focal area, in which the periodic nano-plate structure (6) is formed, is from 0.2 μJ to 0.3 μJ.

4. Method according to any one of claims 1-3, characterized in that the number of linearly polarized USPLR pulses in the sequence (16) for the formation of a nano-plate structure (6) is selected in the range from 1000 to 2000.
